(19) United States
(12) Patent Application Publication
(10) Pub. No.: US 2016/0072128 A1
(43) Pub. Date: Mar. 10, 2016

(54) MANGANESE HEXACYANOMANGANATE AS A HIGH-CAPACITY POSITIVE ELECTRODE FOR RECHARGEABLE BATTERIES

(71) Applicant: Board of Trustees of the Leland Stanford Junior University, Palo Alto, CA (US)

(72) Inventors: Mauro Pasta, Ubiale Clanezzo (IT); Hyun-Wook Lee, Stanford, CA (US); Richard Wang, Stanford, CA (US); Yi Cui, Stanford, CA (US)

(21) Appl. No.: 14/846,244

(22) Filed: Sep. 4, 2015

Related U.S. Application Data
(60) Provisional application No. 62/047,518, filed on Sep. 8, 2014.

(51) Int. Cl. H01M 4/58; H01M 10/054; H01M 10/056

(52) U.S. Cl. CPC H01M 4/5825; H01M 10/056; H01M 10/054

(57) ABSTRACT

Described here is a rechargeable battery comprising (a) an electrode comprising manganese hexacyanomanganate in contact with (b) an electrolyte comprising sodium and/or potassium ions. Also described here is a method for making a sodium-ion rechargeable battery, comprising incorporating manganese hexacyanomanganate into an electrode, and contacting said electrode with an electrolyte comprising sodium ions or potassium ions.

### CROSS-REFERENCE TO RELATED APPLICATIONS

This application claims the benefit of U.S. Provisional Patent Application No. 62/047,518 filed Sep. 8, 2014, the content of which is incorporated herein by reference in its entirety.

### FEDERAL FUNDING STATEMENT

This invention was made with Government support under Contract No. DEA C05-76RL01830, awarded by U.S. Department of Energy. The Government has certain rights in the invention.

### BACKGROUND

The integration of variable renewable energy sources, like solar and wind power, into the electrical grid necessitates the deployment of large-scale energy storage systems. Widespread use of such systems would also help to regulate power quality, improve grid stability, and decrease the use of carbon-intensive coal and natural gas peaker plants. Battery-based electrochemical storage is particularly attractive because of its high performance and ease of deployment, and lithium-ion batteries (LIBs) are one of the most well-developed of these options. Sodium-ion batteries (SIBs), which replace lithium with abundant and inexpensive sodium, have received a great deal of attention recently. Similarities in manufacturing process between SIBs and LIBs may significantly accelerate their technological advance. Nevertheless, several scientific challenges still need to be resolved before the performance of SIBs becomes competitive with that of LIBs. In particular, the higher negative redox potential of Na compared to that of Li results in lower cell voltages and consequently lower energy densities. Moreover, the larger size of Na⁺ relative to Li⁺ (1.02 vs. 0.69 Å) causes slower solid-state diffusion in the active materials and leads to lower energy efficiencies when the batteries are rapidly charged or discharged. High capacity electrode materials with fast solid-state kinetics are therefore desired in order to compensate for these challenges of SIBs. In the past, researchers have explored the possibility of adapting cathode materials of LIBs, including sodium super ionic conductor (NASICON) structures, layered oxides, tunnel-structured oxides, and fluorophosphates, for Na′ intercalation. However, close-packed, oxide-ion arrays connected by first-row transition metal elements do not have enough empty space in the structure for rapid Na′ diffusion. This is why layered-oxide structures, like LiNi_{0.33}Mn_{0.33}Co_{0.33}O₂ for LIBs, are promising candidates from a specific capacity standpoint but suffer from poor Na transport kinetics. On the other hand, NASICON and fluorophosphates exhibit better rate performance, but their bulky 3D network structures limit their specific capacity.

### SUMMARY

Described herein is a rechargeable battery comprising (a) an electrode comprising manganese hexacyanomanganate in contact with (b) an electrolyte comprising sodium ions or potassium ions. In some embodiments, the electrode is a cathode, and the battery also comprises (c) an anode in contact with the electrolyte.

In some embodiments, the rechargeable battery is a sodium-ion battery. In some embodiments, the rechargeable battery is a potassium-ion battery.

In some embodiments, the manganese hexacyanomanganate has an open framework crystal structure into which the ions are reversibly inserted during operation of the battery.

In some embodiments, the electrode comprises faceted cubic crystals of manganese hexacyanomanganate having at least one dimension of about 1 μm or less, or about 500 nm or less, or about 200 nm or less, or about 100 nm or less. For example, the faceted cubic crystals can have at least one dimension from about 1 nm to about 1 μm, from about 1 nm to about 900 nm, from about 10 nm to about 900 nm, from about 10 nm to about 800 nm, from about 10 nm to about 700 nm, from about 10 nm to about 600 nm, from about 10 nm to about 500 nm, from about 10 nm to about 400 nm, from about 10 nm to about 300 nm, from about 10 nm to about 200 nm, or from about 10 nm to about 100 nm. In some embodiments, the manganese hexacyanomanganate is monoclinic or includes a monoclinic crystalline phase.

In some embodiments, a mass loading of the manganese hexacyanomanganate in the electrode is at least about 1 mg cm⁻², or at least about 2 mg cm⁻², or at least about 5 mg cm⁻², or at least about 10 mg cm².

In some embodiments, the electrode has a discharge capacity at C/5 of at least about 160 mAh g⁻¹, or at least about 170 mAh g⁻¹, or at least about 180 mAh g⁻¹, or at least about 190 mAh g⁻¹, or at least about 200 mAh g⁻¹.

In some embodiments, the electrode has a discharge capacity at 1 C of at least about 140 mAh g⁻¹, or at least about 150 mAh g⁻¹, or at least about 160 mAh g⁻¹, or at least about 170 mAh g⁻¹, or at least about 180 mAh g⁻¹.

In some embodiments, the electrode has a discharge capacity at 5 C of at least about 115 mAh g⁻¹, or at least about 125 mAh g⁻¹, or at least about 135 mAh g⁻¹, or at least about 145 mAh g⁻¹, or at least about 155 mAh g⁻¹.

In some embodiments, the battery has an average Coulombic efficiency, after 100 cycles at C/5, of at least about 90%, or at least about 95%, or at least about 98%, or at least about 99%.

In some embodiments, the battery has an average Coulombic efficiency, after 100 cycles at C/2, of at least about 90%, or at least about 95%, or at least about 98%, or at least about 99%.

In some embodiments, the battery has an average Coulombic efficiency, after 100 cycles at 1 C, of at least about 90%, or at least about 95%, or at least about 98%, or at least about 99%.

In some embodiments, the battery has an average Coulombic efficiency, after 100 cycles at 2 C, of at least about 90%, or at least about 95%, or at least about 98%, or at least about 99%.

In some embodiments, the battery has an average Coulombic efficiency, after 100 cycles at 5 C, of at least about 90%, or at least about 95%, or at least about 98%, or at least about 99%.

In some embodiments, the battery has a retention of its initial or maximum discharge capacity, after 100 cycles at a rate of C/5, of at least about 60%, or at least about 70%, or at least about 80%, or at least about 90%.

In some embodiments, the battery has a retention of its initial or maximum discharge capacity, after 100 cycles at a rate of C/2, of at least about 60%, or at least about 70%, or at least about 80%, or at least about 90%.

In some embodiments, the battery has a retention of its initial or maximum discharge capacity, after 100 cycles at a rate of 1 C, of at least about 60%, or at least about 70%, or at least about 80%, or at least about 90%.

In some embodiments, the battery has a retention of its initial or maximum discharge capacity, after 100 cycles at a rate of 2 C, of at least about 60%, or at least about 70%, or at least about 80%, or at least about 90%.

In some embodiments, the battery has a retention of its initial or maximum discharge capacity, after 100 cycles at a rate of 5 C, of at least about 60%, or at least about 70%, or at least about 80%, or at least about 90%.

Also described is a method for making a rechargeable battery, comprising incorporating manganese hexacyanomanganate into an electrode, and contacting said electrode with an electrolyte comprising sodium and/or potassium ions.

These and other features, together with the organization and manner of operation thereof, will become apparent from the following detailed description when taken in conjunction with the accompanying drawings.

### BRIEF DESCRIPTION OF THE DRAWINGS

FIGS. 1A-1D show structure and morphology of as-synthesized Na₂Mn[Mn(CN)₆]. (FIG. 1A) The schematic of the crystal structure for NaMnHCMn shows 8 large interstitial sites and nonlinear Mn—C=N—Mn linkages. (FIG. 1B) Refinement of synchrotron X-ray diffraction data shows that as-synthesized NaMnHCMn has a monoclinic phase. (FIG. 1C) SEM and (FIG. 1D) TEM images show the morphology of NaMnHCMn, which is composed of faceted cubes approximately 100 nm in size. The lattice fringes in the TEM image, which demonstrate crystallinity of the material, are not stable because NaMnHCMn deteriorates under irradiation from the electron beam.

FIGS. 2A-2C show electrochemical properties of NaMnHCMn. (FIG. 2A) Galvanostatic charge and discharge curves at C/5, 1 C, and 5 C. (FIG. 2B) With increasing C rate, the initial discharge capacity decreases, but the capacity retention after 20 cycles actually increases. (FIG. 2C) NaMnHCMn exhibits promising capacity retention over 100 cycles at 2 C with high Coulombic efficiency.

FIGS. 3A-3D show ex situ analysis showing the structural transition and insertion of Na at each reaction plateau. (FIG. 3A) The ex situ samples were prepared by initially discharging and then charging to the endpoints of each reaction plateau. (FIG. 3B) Energy-dispersive X-ray spectroscopy (EDS) data shows varying Na concentrations with cycling. (FIG. 3C) Synchrotron XRD patterns of NaMnHCMn with Mn^{2+/1+}, Mn^{2+/2+}, Mn^{2+/3+}, and Mn^{3+/3+} illustrate the different structures and space groups associated with each redox state. (FIG. 3D) The schematic diagrams illustrate the changes in structure for NaMnHCMn during battery cycling.

FIG. 4 shows the schematic illustrations of PBAs with cubic structure. The general structure of open-framework PBAs comprises a face-centered cubic phase of AₓP[R(CN)₆]_{1-y}.□_{y}.nH₂O (A: mobile cations; P: nitrogen-coordinated transition metal; R: carbon-coordinated transition metal; □: [R(CN)₆] vacancy; 0≦x≦2; y<1). Due to the large-size cyanide bonding, sub-unit cells contain a large interstitial site.

FIGS. 5A and 5B show the schematic illustrations of the crystal structure for NaMnHCMn. a-axis is placed to (FIG. 5A) upwards and (FIG. 5B) forwards. The monoclinic lattice roughly corresponds to a distorted cubic lattice in which b_{M} and c_{M} correspond to bisected face diagonals of the cubic structure as a_{M}=a_{C} and \sqrt{b_{M}²+a_{M}²}=a_{C}.

FIG. 6 shows measurement of the potential of an Ag/AgCl mesh reference electrode. Cyclic voltammograms of 1 mM Ferrocene in 1 M NaClO₄/propylene carbonate on a Pt working electrode at different scan rates of 2, 10, 20 mV s⁻¹. The electrode potentials were measured with respect to the Ag/AgCl mesh electrode and relative to the Ferrocene and Ferrocenium (Fc⁺/Fc) redox couple after cell characterization to confirm the potential of reference electrode. The Fc⁺/Fc couple is a suitable reference for potentials measured because Ferrocene undergoes an one-electron oxidation at a low potential of 0.64 V vs. SHE.

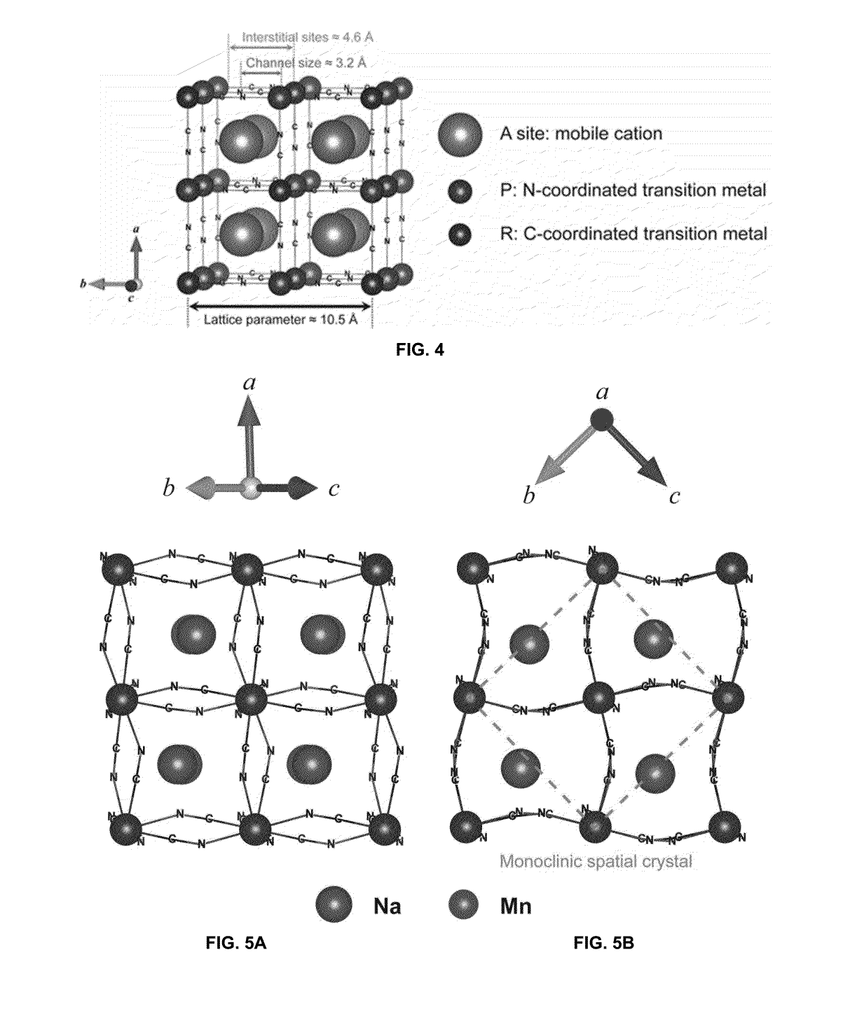

FIG. 7 shows cycling performance of NaMnHCMn in Na-ion battery. Capacity retention of NaMnHCMn as a function of cycle numbers shows promising capacity over 200 mAh g⁻¹ and retains with high Coulombic efficiency at C/5.

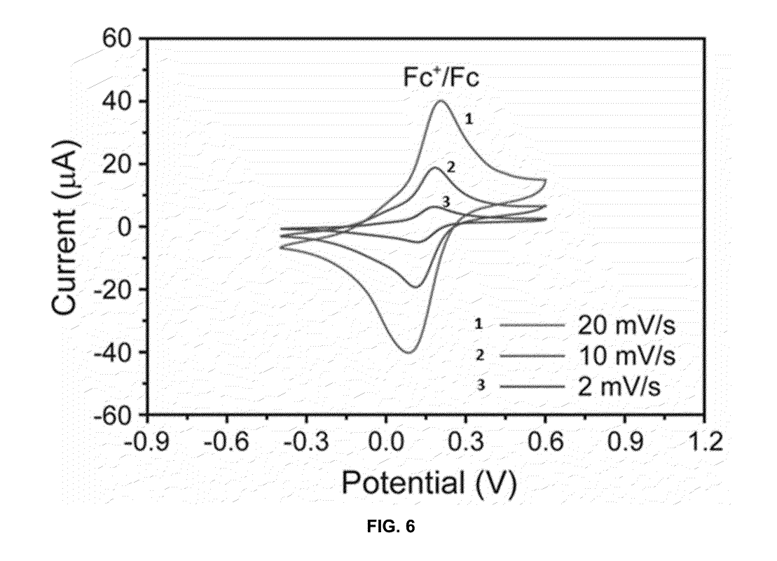

FIG. 8 shows ex situ XPS data of NaMnHCMn. X-ray photoelectron spectroscopy (XPS) spectra exhibit changing binding energies for Mn and Na after some of the redox reactions. The ex situ XPS data show the different binding energy of 641.1, 641.6 and 642.1 eV in the range of Mn 2p_{3/2} during cycling due to the valence state of Mn. The other peaks overlap the identical position during reaction due to the indistinct chemical bonding of Mn. The peak intensity of Na consistently changes as the material contains Na ions during electrochemical reaction.

FIGS. 9A-9D show synchrotron ex situ XRD patterns of NaMnHCMn. Synchrotron ex situ XRD patterns of NaMnHCMn with (FIG. 9A) Mn^{2+/1+}, (FIG. 9B) Mn^{2+/2+}, (FIG. 9C) Mn^{2+/3+}, and (FIG. 9D) Mn^{3+/3+} illustrate the different structures and space groups associated with each redox state. All ex situ samples were added to a small amount of NaCl to confirm the exact peak positions, which has cubic fcc peaks and is inactive electrochemically during cycling in propylene carbonate electrolytes.

FIGS. 10A and 10B show the peak transition of synchrotron ex situ XRD patterns of NaMnHCMn. (FIG. 10A) The orthorhombic phase of (c) Mn^{2+/3+} matches with half cubic (d) and monoclinic (b) phases, and the phase of most discharged state (a) shows half monoclinic phase (b) and a new phase. The peak positions of the new phase (▾) show the similar patterns of monoclinic and the overall XRD patterns of (a) also have monoclinic crystal structure. Asterisks (*) indicate the XRD patterns of sodium chloride (NaCl) reference sample which used to compare the peak position and intensity of NaMnHCMn. NaCl was added before the fabrication of the electrode due to the features of an electrochemically inactive and insoluble material in propylene carbonate electrolyte and having representative peak information. (FIG. 10B) Based on the electrochemical performance of each plateau and structural information of XRD, a cubic phase refers to Na⁺ empty sublattice (e) and when Na⁺ ion inserts inside sublattice, the structure of sublattice changes to monoclinic as shown in (f). At the most discharged state, a sublattice contains two Na⁺ ions and the phase changes to more distorted monoclinic as shown in (g). Therefore, the overall crystal phase changes between monoclinic, orthorhombic, and cubic phases during cycling, but when considering a sublattice as each crystal phase, the crystal structure can be simplified as cubic, monoclinic, and more distorted monoclinic phase depending on Na⁺ ion insertion as shown in (FIG. 10B).

FIGS. 11A and 11B show schematic illustration of 2 Na-ions inserted sublattice by geometric consideration. At the discharged state, half of a lattice contains two Na⁺ ions. (FIG. 11A) Na⁺ ions stay towards C-coordinated Mn through c-axis. (FIG. 11B) The distance between two Na⁺ ions can be calculated as 3.1 Å by geometric considerations without considering the attraction and repulsion of electric forces. The distance between Na⁺ and Mn(CN)⁵⁻ ions can be further if the attraction force between these two ions is considered. LiCoO₂ which is the representative layered oxide structure has the distance of 2.81 Å between two Li⁺ ions, and also the distance between Na⁺ ions in P2-type Naₓ(Fe_{1/2}Mn_{1/2})O₂ has 2.96 Å. Therefore, the open framework NaMnHCMn has large enough space to contain two Na⁺ ions in a sublattice by geometric considerations.

FIG. 12 shows schematic illustration of CN bonding distortion when Na⁺ ion is inserted and the distribution of electrons in t_{2g} and e_{g} orbitals for high and low spin Mn²⁺ ions. Based on molecular-field theory, the octahedral crystal field splits the five 3d orbitals of Mn²⁺ ions into low energy t_{2g} (d_{xy}, d_{yz}, d_{zx}) and high energy e_{g} (d_{z2}, d_{(x2-y2)}) orbitals. Due to splitting and pairing energies of these orbitals, N-coordinated Mn²′ ions become high spin state and C-coordinated Mn²⁺ ions are low spin state. A large distance between two high and low spin Mn²⁺ ions is counter-indicative of direct overlap of the orbitals but the superexchange interaction of the two Mn²⁺ ions can be generated through CN ligands. The CN ligands alter either positive or negative symmetry so the bent CN ligands take place.

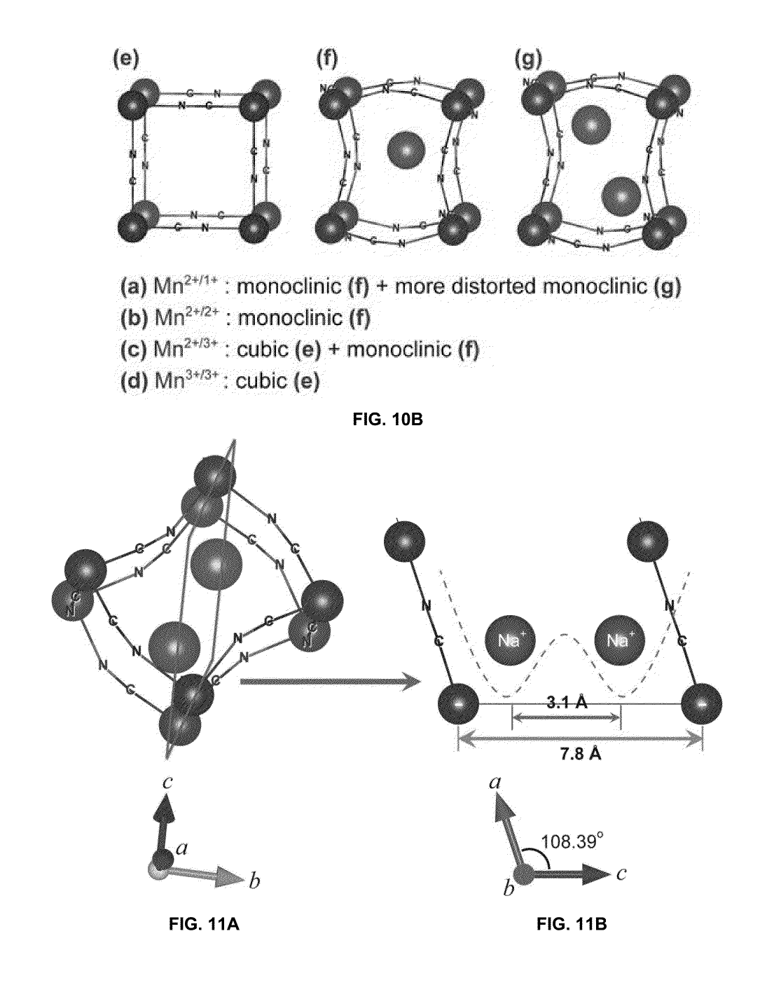

FIG. 13 shows unit cell parameters as a viewpoint of cubic setting. Each redox reaction plateau changes the lattice parameter less than 3%. Small lattice expansion or shrinkage suggests stable fast kinetics with such 210 mAh g⁻¹ capacity as the structural viewpoints.

FIG. 14A shows cyclic voltammogram of MnHCMn with K⁺ ion insertion which shows three distinct reactions; and FIG. 14B shows galvanostatic charge and discharge curves at C/5 with K⁺ ion. This demonstrates that the MnHCMn electrode materials described herein also work with potassium ions in addition to sodium ions.

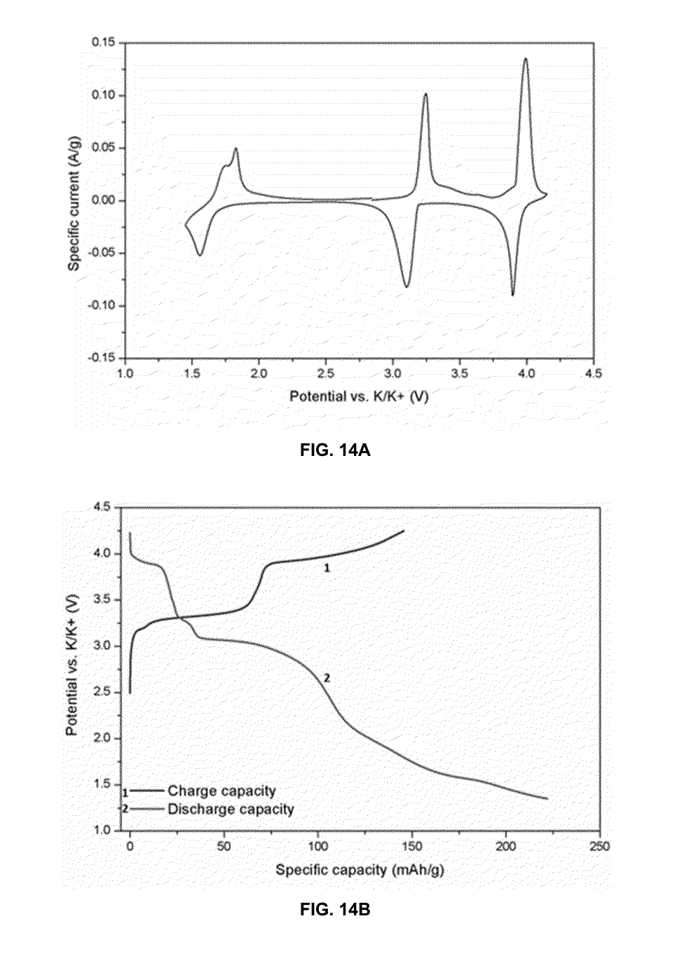

FIG. 15 shows schematic of an example sodium ion battery.

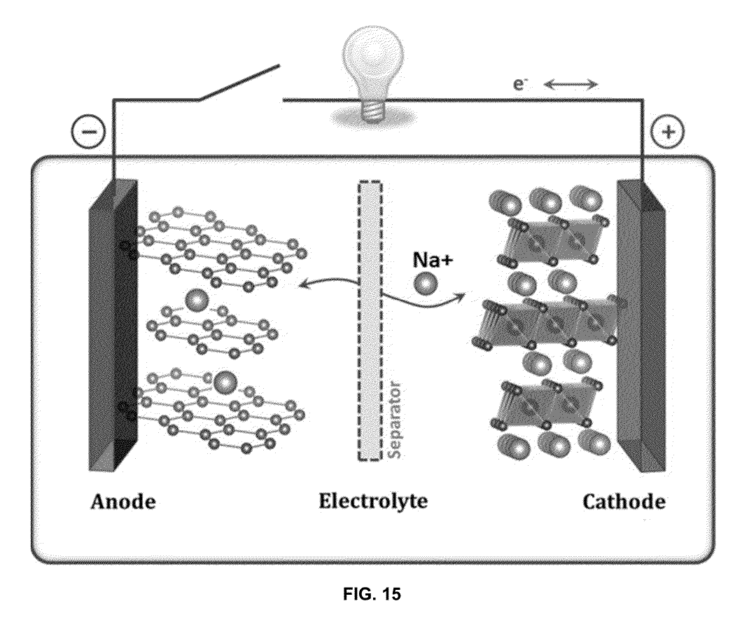

### DETAILED DESCRIPTION

### Manganese Hexacyanomanganate Electrodes for Rechargeable Batteries

Embodiments described herein relate to a rechargeable battery comprising an electrode comprising manganese hexacyanomanganate in contact with an electrolyte comprising sodium ions or potassium ions. The electrode comprising manganese hexacyanomanganate can be a cathode, and the battery can further comprises anode in contact with the electrolyte. The rechargeable battery can comprise an aqueous electrolyte or an organic electrolyte.

The rechargeable battery can be, for example, a sodium-ion battery. The rechargeable battery can be, for example, a potassium-ion battery. In one embodiment, the electrode comprises sodium manganese hexacyanomanganate. In another embodiment, the electrode comprises potassium manganese hexacyanomanganate.

The manganese hexacyanomanganate can comprise, for example, an open framework crystal structure into which at least one alkali metal cation is reversibly inserted during operation of the battery. In one embodiment, the manganese hexacyanomanganate comprises an open framework crystal structure into which sodium ions are reversibly inserted during operation of the battery. In another embodiment, the manganese hexacyanomanganate comprises an open framework crystal structure into which potassium ions are reversibly inserted during operation of the battery.

The electrode can comprise, for example, faceted cubic crystals of manganese hexacyanomanganate having at least one dimension (e.g., an average or median size) of no greater than about 10 μm, no greater than about 5 μm, no greater than about 1 μm, no greater than about 900 nm, no greater than about 800 nm, no greater than about 700 nm, no greater than about 600 nm, no greater than about 500 nm, no greater than about 400 nm, no greater than about 300 nm, no greater than about 200 nm, or no greater than about 100 nm, and down to about 20 nm, down to about 10 nm, down to about 5 nm, or less. The faceted cubic crystals can have at least one dimension from about 1 nm to about 1 μm, or from about 1 nm to about 900 nm, from or about 10 nm to about 900 nm, or from about 10 nm to about 800 nm, or from about 10 nm to about 700 nm, or from about 10 nm to about 600 nm, or from about 10 nm to about 500 nm, or from about 10 nm to about 400 nm, or from about 10 nm to about 300 nm, or from about 10 nm to about 200 nm, or from about 10 nm to about 100 nm. The manganese hexacyanomanganate can be monoclinic or include a monoclinic crystalline phase.

### Process for Making Manganese Hexacyanomanganate Electrodes

For implementation within a battery, the manganese hexacyanomanganate can be incorporated as an active material by mixing with a conductive material and a binder to form a slurry, and this slurry can be deposited adjacent to a substrate, dried to form a coating, a film, or other layer adjacent to the substrate, and then assembled as an electrode into the battery. Examples of suitable conductive materials include carbon black, acetylene black, graphite, vapor grown fiber carbon, and carbon nanotubes, and examples of suitable binders include polyvinylidene fluoride and other types of polymeric binders. A thickness of the electrode coating can be at least about 500 nm, at least about 1 μm, at least about 10 μm, at least about 20 lam, at least about 30 μm, at least about 40 μm, or at least about 50 μm, and up to about 150 μm, up to about 200 μm, up to about 300 μm, up to about 500 μm, or more. A mass loading of the active material on the substrate can be at least about 500 μg/cm², at least about 700 μg/cm², at least about 1 mg/cm², at least about 2 mg/cm², at least about 3 mg/cm², at least about 4 mg/cm², or at least about 5 mg/cm², and up to about 10 mg/cm², up to about 15 mg/cm², up to about 20 mg/cm², up to about 30 mg/cm², up to about 50 mg/cm², up to about 100 mg/cm², or more.

The slurry or the electrode coating obtained can comprise, for example, about 30-98 wt. %, or about 50-95 wt. %, or about 70-90 wt. %, or about 80 wt. % of manganese hexacyanomanganate. The slurry or the electrode coating obtained can comprise, for example, about 1-30 wt. %, or about 5-20 wt. %, or about 10-15 wt. % of conductive materials. The slurry or the electrode coating obtained can comprise, for example, about 1-20 wt. %, or about 2-15 wt. %, or about 5-10 wt. % of binders.

Operation of Batteries with Manganese Hexacyanomanganate Electrodes

The operation of the battery can be based upon reversible intercalation of cations from the electrolyte into at least one of the cathode and the anode. Other implementations of the battery are contemplated, such as those based on conversion or displacement chemistry. In some embodiments, at least one of the cathode and the anode is formed using an electrode material comprising manganese hexacyanomanganate. In one embodiment, the cathode is formed using an electrode material comprising manganese hexacyanomanganate. The ability of manganese hexacyanomanganate to reversibly intercalate a variety of cations allows the battery to be implemented as a hybrid-ion electrolyte battery, in which one electrode (e.g., the cathode) reacts with one type of cation, and another electrode (e.g., the anode) reacts with a different type of cation. One example is where the electrolyte is a dual-ion electrolyte including Na⁺ and K⁺, the cathode reacts with Na⁺, and the anode reacts with K. In addition to Na⁺/K⁺, other examples include combinations such as H⁺/Li⁺, Na⁺/Li⁺, K⁺/K⁺, H⁺/Na⁺, H⁺/K⁺, as well as combinations including NH₄⁺. The electrolyte also can be implemented as a single-ion electrolyte, where the cathode and the anode react with the same type of cation.

In some embodiments, the electrode comprising manganese hexacyanomanganate has a discharge capacity at C/5 of at least about 160 mAh g⁻¹, or at least about 170 mAh g⁻¹, or at least about 180 mAh g⁻¹, or at least about 190 mAh g⁻¹, or at least about 200 mAh g⁻¹. In some embodiments, the electrode comprising manganese hexacyanomanganate has a discharge capacity at 1 C of at least about 140 mAh g⁻¹, or at least about 150 mAh g⁻¹, or at least about 160 mAh g⁻¹, or at least about 170 mAh g⁻¹, or at least about 180 mAh g⁻¹. In some embodiments, the electrode comprising manganese hexacyanomanganate has a discharge capacity at 5 C of at least about 115 mAh g⁻¹, or at least about 125 mAh g⁻¹, or at least about 135 mAh g⁻¹, or at least about 145 mAh g⁻¹, or at least about 155 mAh g⁻¹.

In some embodiments, the battery has an average Coulombic efficiency, after 100 cycles at C/5, of at least about 90%, or at least about 95%, or at least about 98%, or at least about 99%. In some embodiments, the battery has an average Coulombic efficiency, after 100 cycles at C/2, of at least about 90%, or at least about 95%, or at least about 98%, or at least about 99%. In some embodiments, the battery has an average Coulombic efficiency, after 100 cycles at 1 C, of at least about 90%, or at least about 95%, or at least about 98%, or at least about 99%. In some embodiments, the battery has an average Coulombic efficiency, after 100 cycles at 2 C, of at least about 90%, or at least about 95%, or at least about 98%, or at least about 99%. In some embodiments, the battery has an average Coulombic efficiency, after 100 cycles at 5 C, of at least about 90%, or at least about 95%, or at least about 98%, or at least about 99%.

In some embodiments, the battery has a retention of its initial or maximum discharge capacity, after 100 cycles at a rate of C/5, of at least about 60%, or at least about 70%, or at least about 80%, or at least about 90%. In some embodiments, the battery has a retention of its initial or maximum discharge capacity, after 100 cycles at a rate of C/2, of at least about 60%, or at least about 70%, or at least about 80%, or at least about 90%. In some embodiments, the battery has a retention of its initial or maximum discharge capacity, after 100 cycles at a rate of 1 C, of at least about 60%, or at least about 70%, or at least about 80%, or at least about 90%. In some embodiments, the battery has a retention of its initial or maximum discharge capacity, after 100 cycles at a rate of 2 C, of at least about 60%, or at least about 70%, or at least about 80%, or at least about 90%. In some embodiments, the battery has a retention of its initial or maximum discharge capacity, after 100 cycles at a rate of 5 C, of at least about 60%, or at least about 70%, or at least about 80%, or at least about 90%.

In some embodiments, the battery has a reference specific capacity when cycled at a reference rate, and at least about 70%, or at least about 80%, or at least about 90%, or at least about 95% of the reference specific capacity is retained when the battery is cycled at 5 times the reference rate. In some embodiments, the battery has a reference specific capacity when cycled at a reference rate, and at least about 60%, or at least about 70%, or at least about 80%, or at least about 90% of the reference specific capacity is retained when the battery is cycled at 10 times the reference rate. In some embodiments, the battery has a reference specific capacity when cycled at a reference rate, and at least about 50%, at least about 60%, or at least about 70%, or at least about 80% of the reference specific capacity is retained when the battery is cycled at 25 times the reference rate.

### Additional Descriptions

Rechargeable, durable, cost-effective, and efficient energy storage technologies are desired to sustain the growing penetration of transient renewable energy sources, such as solar and wind power, in the electrical grid. Sodium-ion batteries have been proposed as an alternative to lithium-ion batteries because of the availability of sodium. Manganese hexacyanomanganate, such as Na₂Mn^{II}[Mn^{II}(CN)₆](NaMnHCMn), is a viable positive electrode for sodium-ion batteries and potassium-ion batteries. Its open framework, Prussian Blue-like crystal structure provides a discharge capacity of 210, 180, and 155 mAh g⁻¹ at C/5 (40 mA g⁻¹), 1 C (200 mA g⁻¹), and 5 C (1 A g⁻¹) with an average discharge voltage of 2.65 V versus Na⁰/Na⁺ in a propylene carbonate electrolyte. The high capacity is the result of sodium-ion displacement in cavities of the nanoporous crystal structure upon cycling as demonstrated by electrochemical investigation and synchrotron X-ray diffraction studies.

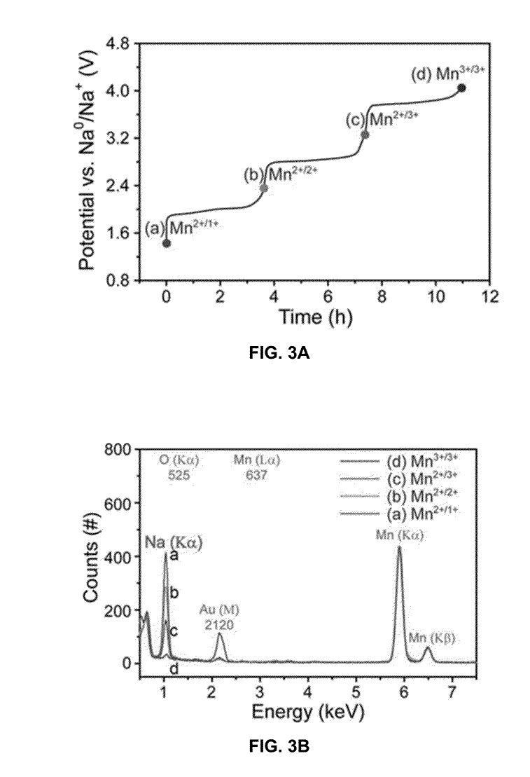

Prussian Blue analogues (PBAs) have been explored for many different applications because of their ease of synthesis and intriguing electrochemical and magnetic properties. Their general chemical formula is AₓP[R(CN)₆]_{1-y}.□_{y}.nH₂O (A: mobile cations; P: nitrogen-coordinated transition metal ion; R: carbon-coordinated transition metal ion; □: [R(CN)₆] vacancy; 0≦x≦2; 0≦y<1). PBAs typically possess a face-centered cubic crystal structure with the Fm-3m space group, and transition metal ions are linked together with cyanide (CN) ligands (FIG. 4). Each cubic sub-unit cell contains an interstitial site that can host various ions, such as Li⁺, Na⁺, K⁺, NH₄⁺, Rb⁺, alkaline earth divalent ions, and zeolitic water. The open framework nature of the cubic structure, which contains open <100> channels (3.2 Å in diameter) and interstitial sites (4.6 Å in diameter) in the case of Prussian Blue, allows rapid solid-state diffusion of a wide variety of ions. The electrochemical properties of PBAs can be ascribed to the redox behavior of the transition metal ions in either the P or R sites:

P[R(CN)₆]+A⁺+e⁻+ [symbol] A₁P[R(CN)₆] or

A₁P[R(CN)₆]+A⁺+e⁻+ [symbol] A₂P[R(CN)₆]

Depending on the type of transition metal ions, their oxidation states, the concentration and type of cations in the interstitial sites, and the concentration of hexacyanometallate vacancies, structural transitions of the original cubic structure to monoclinic, rhombohedral, or orthorhombic structures may occur. These modifications are triggered by a distortion of the CN bonding and are generally believed not to affect the number of interstitial sites and ions that can be stored within the structure. In the case of a general, vacancy-free PBA, the theoretical capacity is usually around 70-90 or 140-180 mAh g⁻¹ for a 1- or 2-electron/A′ process, respectively, depending on the nature of P, R, and A.

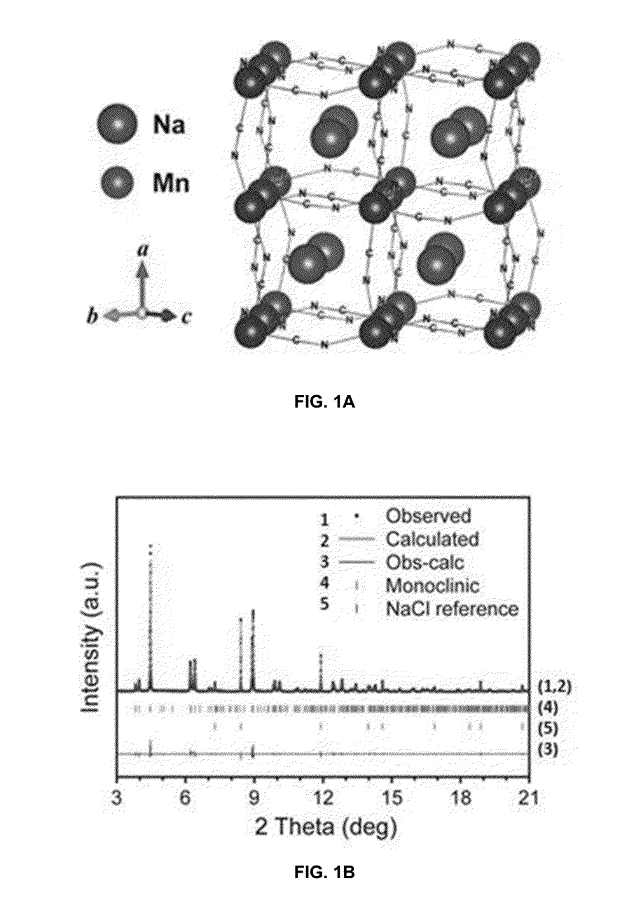

As discussed herein, low-vacancy, sodium manganese hexacyanomanganate (Na₂Mn^{II}[Mn^{II}(CN)₆]=NaMnHCMn) can be a viable cathode material for SIBs. The as-synthesized NaMnHCMn shows a monoclinic crystal structure composed of nonlinear Mn—C≡N—Mn bonds (FIG. 1A) containing eight large interstitial sites occupied by Na⁺ ions. A Mn-based PBA offers several desirable advantages for rechargeable SIBs. Mn is an abundant element, which makes it suitable for low-cost battery applications. In addition, Mn offers several electrochemically accessible valence states that increase the number of possible redox reactions in the structure; this allows the structure to accommodate more cations, which improves the specific capacity. The localized charge distribution within the material also helps it to retain unusually high specific capacity due to a beneficial displacement of cations within the structure. NaMnHCMn comprises positively charged Mn²⁺ bonded to negatively charged [Mn^{II}(CN)₆]⁴⁻. The positively charged Na⁺ ions are drawn along the <111> axes towards the [Mn^{II}(CN)₆]⁴⁻ complexes to stabilize the positive charge of Nat PBAs synthesized by conventional solution procedures exhibit high levels of [Mn^{II}(CN)₆]⁴⁻ vacancies that are occupied by water molecules. The water defects and vacancies interfere with the interaction between insertion and host ions that causes the structural distortion. Substantially vacancy-free NaMnHCMn promotes the distortion that leads to the creation of more ionic sites and higher capacities. A more complete understanding of the displacement of cations and structural transitions in PBAs can lead to a breakthrough for high-capacity Na-ion batteries.

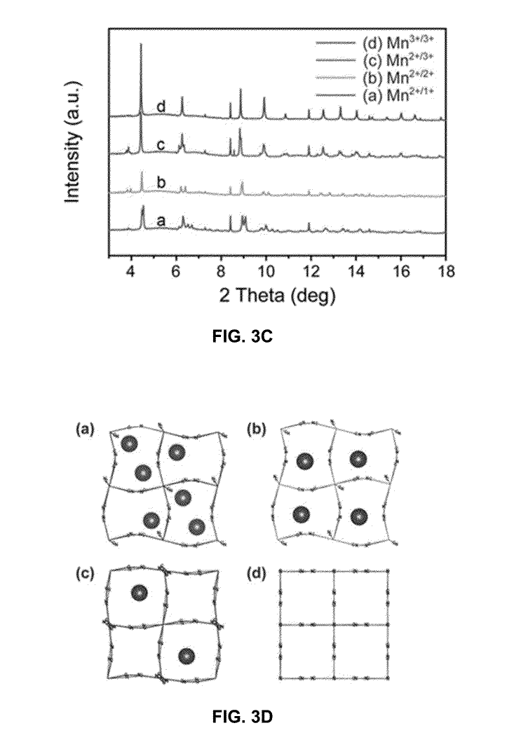

NaMnHCMn was synthesized by the precipitation method described in the working examples below. The precise compositions of as-synthesized materials were determined by elemental analysis and inductively coupled plasma mass spectrometry (ICP-MS) to be Na_{1.96}Mn[Mn(CN)₆]_{0.99}.□_{0.01}, where □ represents a [Mn(CN)₆] vacancy. More generally for some embodiments, an extent of vacancy, as characterized by y, can be no greater than about 0.1, no greater than about 0.09, no greater than about 0.08, no greater than about 0.07, no greater than about 0.06, no greater than about 0.05, no greater than about 0.04, no greater than about 0.03, no greater than about 0.02, or greater than about 0.01. As shown in FIG. 1B, the high-resolution synchrotron X-ray diffraction (XRD) pattern of NaMnHCMn corresponds to a monoclinic structure with the space group P2₁/n. The lattice parameters of NaMnHCMn are a_{M}=10.668 Å, b_{M}=7.602 Å, c_{M}=7.410 Å, α_{M}=γ_{M}=90°, and β_{M}=92.43°. The monoclinic lattice roughly corresponds to a distorted cubic lattice in which b_{M} and c_{M} correspond to bisected face diagonals of the cubic structure (FIGS. 5A and 5B). Thus, the cubic lattice parameter, a_{C}, can be directly compared to the monoclinic lattice parameters, a_{M}, b_{M}, and c_{M}, using the equations a_{M}=a_{C} and \sqrt{b_{M}²+a_{M}²}=a_{C}. When the lattice parameters of monoclinic NaMnHCMn are converted to the cubic counterpart, a_{M}=10.668 Å and \sqrt{b_{M}²+a_{M}²}=10.616 Å. These counterpart lattice parameters are almost equal to each other, which shows that the NaMnHCMn crystal structure corresponds to a distorted version of the general open-framework cubic PBA crystal structure. The morphology and size of NaMnHCMn are confirmed by scanning electron microscopy (SEM) and transmission electron microscopy (TEM) in FIGS. 1C and 1D. The images show well-distributed cubes with an average particle size of 100 nm. The TEM image indicates that the cubic particles have lattice fringes with a single orientation, which makes them highly crystalline. However, the weak CN bonding within the particles is unstable under beam irradiation, so it is difficult to collect high-resolution TEM images. Typical PBAs synthesized in solution possess more structural defects, such as interstitial water molecules and vacancies, which leads to a more disordered and random morphology.

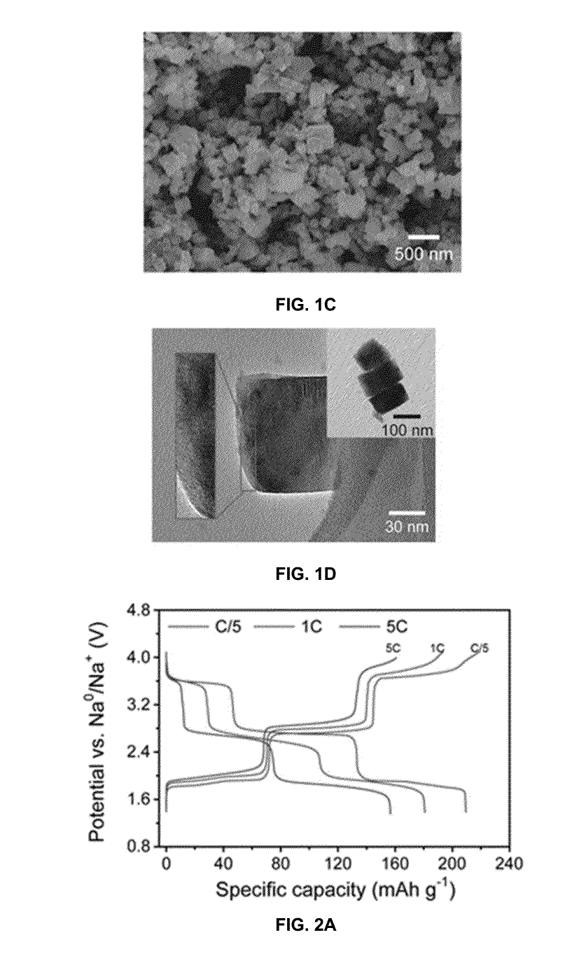

Electrochemical performance of the material as positive electrode is shown in FIGS. 2A-2C. Galvanostatic voltage profiles in FIG. 2A clearly show the reversible specific capacities of NaMnHCMn. The discharge capacity at C/5 (40 mA g⁻¹) reaches 209 mAh g⁻¹, and the charge capacity approaches 218 mAh g⁻¹ at that same rate. The plateaus in the voltage profiles correspond to three redox reactions at about 1.8, 2.65, and 3.55 V versus Na⁰/Na⁺. The reaction potentials become −0.91, −0.06, and 0.84 V relative to the standard hydrogen electrode (SHE) reference potential and correspond to the similar redox potentials of Mn²⁺[Mn(CN)₆]^{5+/4+}, Mn²⁺[Mn(CN)₆]^{4-/3-}, and Mn^{2+/3+}[Mn(CN)₆]³⁻ respectively, according to a study of standard potentials in metal hexacyanometallates. As the cycling rate is increased to 1 C and 5 C, the capacity associated with the high-potential reaction at 3.9 V decreases rapidly relative to the capacities of the two lower-potential reactions. The charge capacity of each of these plateaus is approximately 70 mAh g⁻¹ at C/5. When the C-rate increases to 1 C and beyond, the capacity for the reaction at 3.55 V drastically decreases, whereas the capacity retention remains above 90% and 95% for the reactions at 2.65 and 1.8 V, respectively. The cells were cycled at a variety of rates from C/5 to 5 C to investigate the high power performance of the material, as shown in FIG. 2B. The discharge capacities reached 209, 196, 181, 167, and 157 mAh g⁻¹ when the cell was cycled at C/5, C/2, 1 C, 2 C, and 5 C, respectively, from 1.35 to 4.05 V, whereas the capacity retention after 20 cycles actually increases. Capacity fading is due to a Jahn-Teller distortion of the N-coordinated Mn³′ ions with cycling, but less capacity fading occurs at high C-rates because less of the electrode is converted to the phase containing Mn³⁺ during cycling. Thus, the cycle life data in FIG. 2C illustrates promising capacity retention over 100 cycles at 2 C with high Coulombic efficiency of 99.2%.

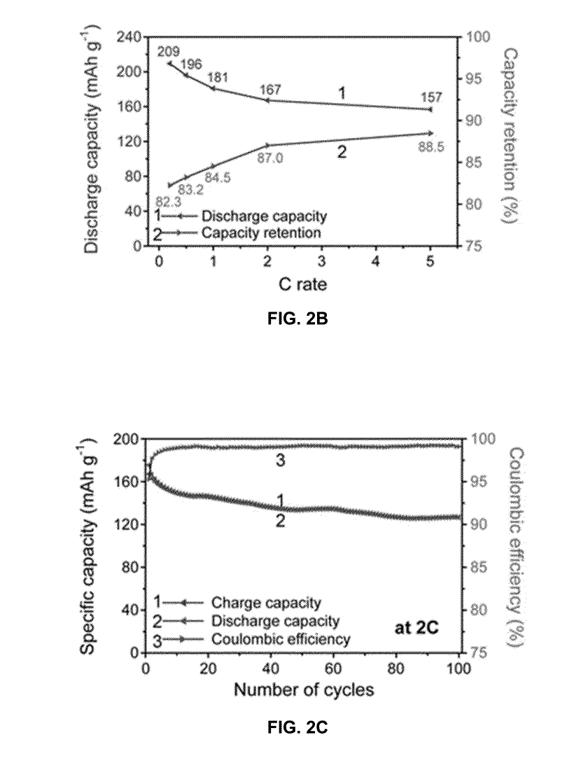

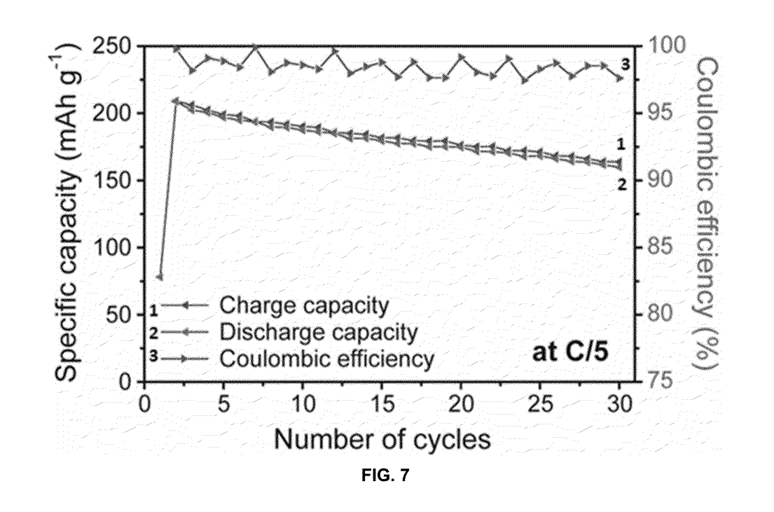

Other studies of ion insertion in PBAs suggest that ions insert primarily in the eight large interstitial sites within each unit cell. The maximum theoretical capacity is limited to 171.8 mAh g⁻¹ for Na₂Mn[Mn(CN)₆] if each interstitial site accommodates one Na ion. However, this theory cannot account for the 209 mAh g⁻¹ specific capacity observed in NaMnHCMn. Ex situ energy-dispersive X-ray spectroscopy (EDX) and synchrotron XRD were used to explore the chemical and the structural characteristics of NaMnHCMn with cycling, as shown in FIGS. 3A-3D, and to help explain the high observed capacity. The amount of Na′ in MnHCMn, which depends on the charge state, was confirmed by ex situ EDX and X-ray photoelectron spectroscopy (XPS) spectra, as shown in FIG. 3B and FIG. 8. The samples were prepared by galvanostatic charge and discharge at C/10 (FIG. 3A). EDX and XPS spectra show increasing intensity of all Na peaks with insertion of Na ions when normalized by the intensity of the Mn peaks. Each plateau during electrochemical titration reaches 60-70 mAh g⁻¹, and the amount of Na insertion with cycling predicted by EDX directly correlates with the amount of Na insertion predicted by the electrochemical data. The agreement between the electrochemical and chemical data supports the hypothesis of Na ions inserting into MnHCMn until it is fully reduced.

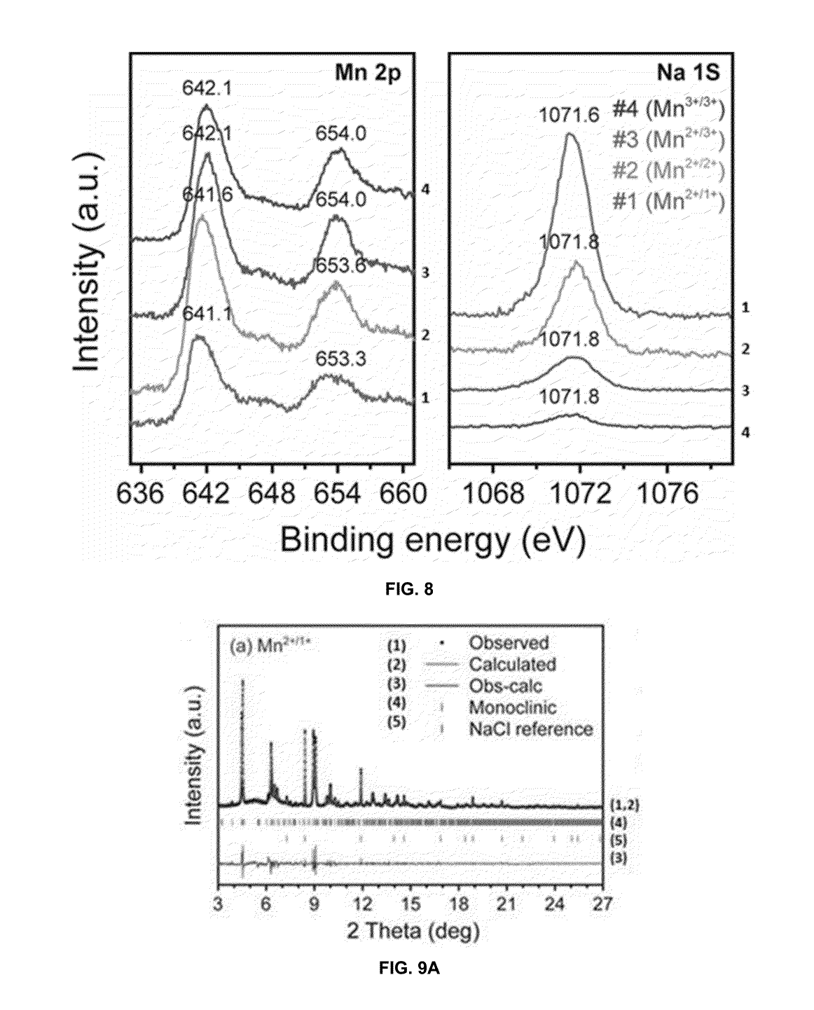

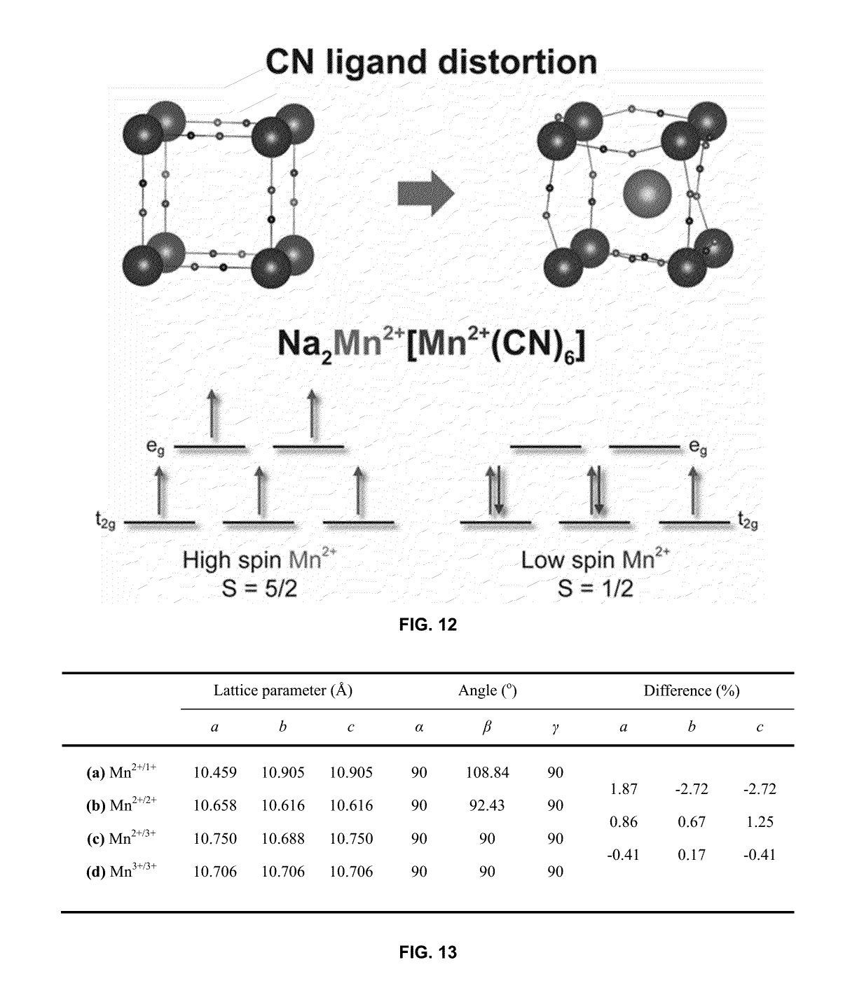

FIG. 3C shows the XRD patterns of NaMnHCMn at the endpoints of each reaction plateau within the initial cycle. Structureless Le Bail fits of the ex situ XRD data were generated to identify the space groups and lattice parameters for NaMnHCMn in each state of oxidation as shown in FIGS. 9A-9D. The as-synthesized NaMnHCMn, which has Mn²′ throughout the structure in both N- and C-coordinated positions, possesses a monoclinic phase with a space group of P2₁/n and the following lattice parameters: a_{M}=10.669 Å, b_{M}=7.605 Å, c_{M}=7.409 Å, α_{M}=γ_{M}=90°, and β_{M}=92.43°. A NaMnHCMn electrode that has been electrochemically reduced and oxidized back to the initial state (sample (b) in FIG. 3A: Mn^{2+/2+}) possesses the same monoclinic space group and lattice parameters as the as-synthesized powder. The XRD data for fully oxidized NaMnHCMn (sample (d) in FIG. 3A: Mn^{3+/3+} shows the typical perovskite cubic peaks corresponding to the Fm-3m space group and lattice parameters of a_{C}=b_{C}=c_{C}=10.706 Å. Le Bail fitting of partially reduced NaMnHCMn (sample (c) in FIG. 3A: Mn²³) confirms the orthorhombic space group P222₁ with lattice parameters of a_{O}=7.724 Å, b_{O}=10.688 Å, c_{O}=7.477 Å. Fitting of the fully reduced NaMnHCMn (sample (a) in FIG. 3A: Mn^{2+/1+}) confirms the monoclinic space group P2₁ with lattice parameters of a_{M′}=11.051 Å, b_{M′}=7.525 Å, c_{M′}=7.862 Å, a_{M′}=γ_{M′}=90°, and β_{M′}=108.84°, which is different from the as-synthesized monoclinic phase. Although these four crystal structures seem to have distinct symmetries and lattice parameters, the orthorhombic and monoclinic cells correspond to slightly distorted versions of the cubic cell if they are rotated by 45° around the a-axis. The orthorhombic and monoclinic lattice parameters can be converted to their corresponding cubic lattice parameters: (a) Mn^{2+/1+}; a_{2+/1+}=10.459 Å and b_{2+/3+}=c_{2+/1+}=10.905 Å, (b) Mn^{2+/2+}: a_{2+/2+}=10.658 Å and b_{2+/2+}=c_{2+/2+}=10.616 Å, and (c) Mn^{2+/3+}: a_{2+/1+}=c_{2+/1+}=10.750 Å and b_{2+/3+}=10.688 Å. The unit cells expand and shrink less than 3% during Na ion insertion relative to the fully charged state (FIG. 13), which reflects the stable crystal structure of open framework Prussian Blue analogues.

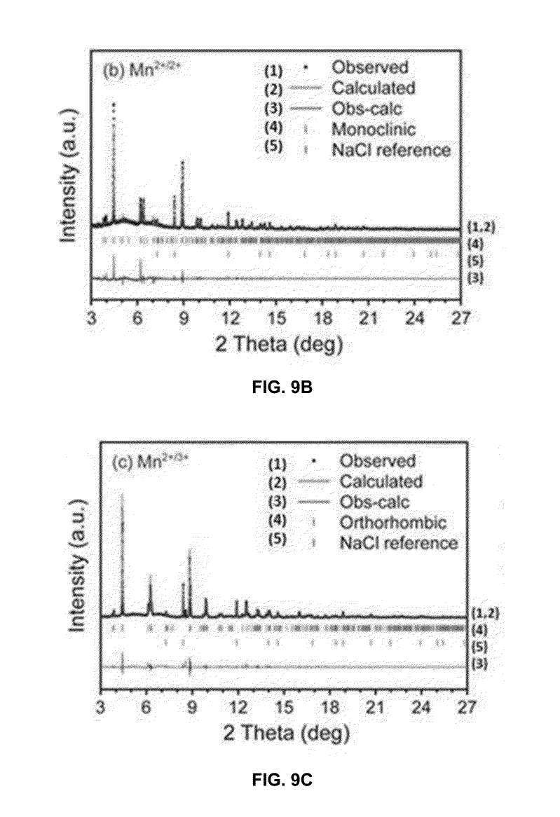

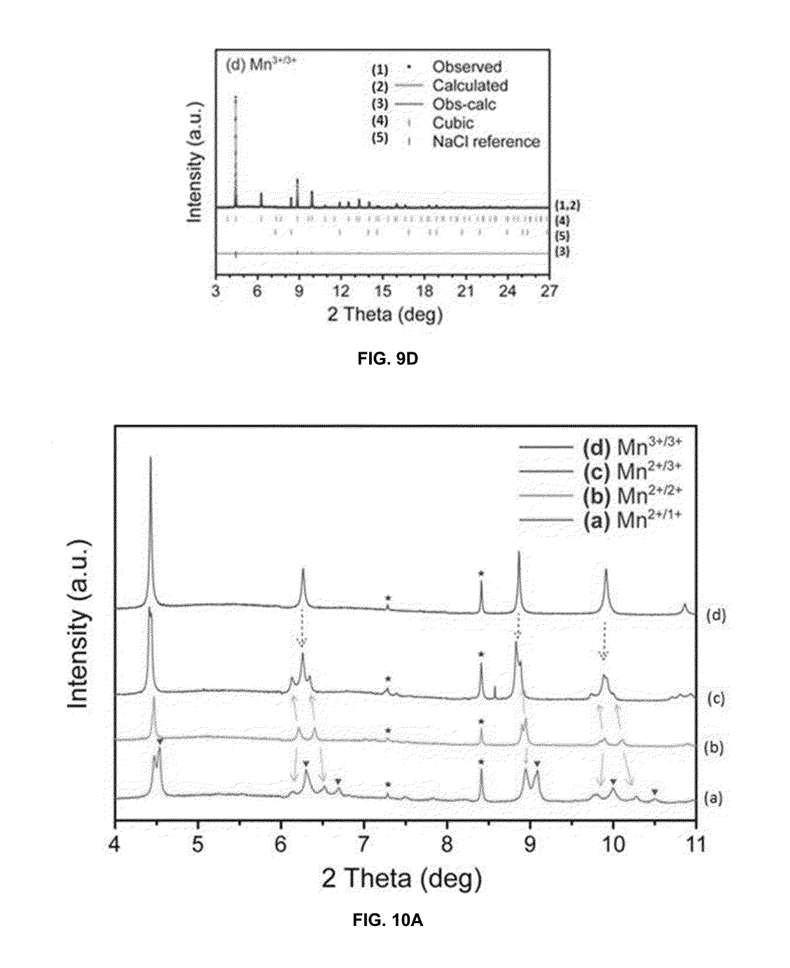

One way to visualize the structural changes upon ion insertion is to assign each sub-unit cell its own local structure. An empty sub-unit cell is cubic, a sub-unit cell with one Na ion is monoclinic, and a sub-unit cell with two Na ions is a more heavily distorted monoclinic shape (FIGS. 10A and 10B). Thus, the orthorhombic phase, which has Na ions occupying half the sub-unit cells, is composed of randomly distributed cubic and monoclinic sub-unit cells. Indeed, several XRD peaks of the (c) Mn^{2+/3+} orthorhombic phase correspond closely in position to those of both the perovskite cubic and as-synthesized monoclinic NaMnHCMn. Likewise, some peaks of the (a) Mn^{2+/1+} monoclinic phase correspond to those of the monoclinic (b) Mn^{2+/2+} phase as shown in FIG. 10, while the remaining peaks match a more heavily distorted monoclinic phase due to the presence of two Na ions within one sub-unit cell. Despite all of these local structural distortions, the overall unit cell does not change much beyond some distortions in the framework as shown in FIG. 3D. The specific capacity observed in NaMnHCMn can be explained by the insertion of two Na ions in roughly half of the sub-unit cells when the material is fully discharged as shown in FIG. 3D. Each sub-unit cell comprises four Mn²⁺ and four [Mn(CN)₆]⁴⁻ in the as-synthesized state with Mn^{2+/2+}. Na⁺ ions are not stable at the octahedral center of the sub-unit cell due to attraction towards the negatively charged [Mn(CN)₆]⁴⁻, which draws the Na⁺ ions in the <111> directions towards the four tetrahedral sites in each sub-unit cell. In the most discharged state (a), the stronger interaction between Na⁺ and [Mn(CN)₆]⁵⁻ drives further displacement of Na ions along with further structural distortion of the sub-unit cell, which creates sufficient space for two Na⁺ ions. Geometric calculations predict a Na⁺—Na⁺ distance of 3.1 Å as shown in FIGS. 11A and 11B. By comparison, the Li⁺—Li⁺ distance in LiCoO₂, a typical layered oxide battery electrode material, is 2.81 Å. Moreover, the Na⁺—Na⁺ distance in P2-type Naₓ(Fe_{1/2}Mn_{1/2})O₂ is 2.96 Å. Thus, the open framework structure of NaMnHCMn has sufficient space for two Na⁺ ions within a sub-unit cell in its fully discharged and distorted form, which explains its high specific capacity.

In conclusion, in the quest to replace Li-ion batteries in energy storage systems, low-cost, earth-abundant, and environmentally benign materials with high performance are preferred. NaMnHCMn, which has an open framework crystal structure, can be synthesized by a co-precipitation method at room temperature that may minimize the processing costs during industrial production. The material is primarily composed of manganese, which is earth-abundant and non-toxic. The reversible capacity of 209 mAh g⁻¹ at an average voltage of 2.65 V versus Na⁰/Na⁺ makes the material promising as a positive electrode material for large-scale applications. This high capacity has been achieved because of the presence of three distinct Na ion insertion steps during cycling. The open framework structure provides structural integrity while allowing for local distortions that can accommodate multiple Na ions, which leads to both fast kinetics and high capacity. Thus, high-capacity open framework NaMnHCMn represents a promising material for the development of commercial Na-ion batteries.

### WORKING EXAMPLES

### Example 1

### Synthesis of NaMnHCMn

Monoclinic sodium manganese (II) hexacyanomanganate (II) NaMnHCMn was prepared by a co-precipitation method. An aqueous solution of Mn(NO₃)₂.4H₂O (0.25 M) was added to an aqueous solution of NaCN (1.28 M) in the presence of an excess of NaCl (50:1 in mol:mol) in a dark container within a N₂-filled glovebox. The blue precipitate was centrifuged, washed twice with 30 mL of distilled H₂O, twice with 30 mL of acetonitrile, and then dried under vacuum for 24 hours at room temperature.

### Example 2

### Materials Characterization

The compositions were determined by the standard microanalytical method for C, H, and N elements and by inductively coupled plasma mass spectroscopy (ICP-MS) for Na and Mn elements. High-resolution synchrotron powder X-ray diffraction (XRD) patterns were obtained with a wavelength of 0.413737 Å through the mail-in program at beamline 11-BM at the Advanced Photon Source at Argonne National Laboratory. XRD patterns were indexed using the CRYSFIRE Powder Indexing System. Le Bail and Rietveld fits for calculating space groups and crystal structures were prepared with GSAS/EXPGUI. For elemental analysis, transmission electron microscopy (FEI Tecnai G² F20 X-Twin microscope, acceleration voltage 200 kV) equipped with an EDX spectrometer was used. To avoid the peak overlap of Na Kα and Cu Lα, Au grid was employed to find out the Na concentration clearly. The relative amounts of Na ions in each sample were determined by comparing the ratios of the integrated peak areas near 1 keV for Na and from 5.6 to 6.8 keV for Mn. The absolute ionic ratios were calibrated to the composition of as-synthesized NaMnHCMn using data from ICP-MS mentioned above. Typically, the EDX acquisition time was 300 s for all spectra, which allows for good signal-to-noise ratios.

### Example 3

### Electrochemical Measurement

To prepare electrodes, 80 wt. % active material of NaMnHCMn, 13 wt. % carbon black (Timcal Super P Li), and 7 wt. % polyvinylidene fluoride (PVDF, Kynar HSV 900) were ground by an agate mortar in 1-methyl-2-pyrrolidone (NMP) to form a slurry. The slurry of NaMnHCMn working electrodes were coated on a carbon cloth current collector (Fuel Cell Earth/Ballard AvCarb) with mass loadings of about 10 mg cm⁻². Afterwards the electrodes were dried in vacuum at room temperature for 10 hours. Electrochemical measurements were performed on flooded three-electrode cells. The cells contain a chloridized Ag/AgCl mesh as a reference electrode and an activated carbon counter electrode. Each chloridized Ag/AgCl mesh electrode was calibrated by measurement of the relative Ferrocene (Fc 4c) redox couple. Electrochemical characterizations were performed using BioLogic VMP3 multi-channel battery tester at room temperature.

As used herein, the singular terms “a,” “an,” and “the” include plural referents unless the context clearly dictates otherwise. Thus, for example, reference to a molecule can include multiple molecules unless the context clearly dictates otherwise.

As used herein, the terms “approximately,” “substantially,” “substantial,” and “about” are used to describe and account for small variations. When used in conjunction with an event or circumstance, the terms can refer to instances in which the event or circumstance occurs precisely as well as instances in which the event or circumstance occurs to a close approximation. For example, the terms can refer to less than or equal to ±10%, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

In the foregoing description, it will be readily apparent to one skilled in the art that varying substitutions and modifications may be made to the invention disclosed herein without departing from the scope and spirit of the invention. The invention illustratively described herein suitably may be practiced in the absence of any element or elements, limitation or limitations, which is not specifically disclosed herein. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention. Thus, it should be understood that although the present invention has been illustrated by specific embodiments and optional features, modification and/or variation of the concepts herein disclosed may be resorted to by those skilled in the art, and that such modifications and variations are considered to be within the scopes of this invention.

What is claimed is:

1. A rechargeable battery comprising:
(a) an electrode comprising manganese hexacyanomanganate; and
(b) an electrolyte in contact with the electrode, the electrolyte comprising sodium ions or potassium ions.

2. The battery of claim 1, wherein the battery is a sodium-ion battery.

3. The battery of claim 1, wherein the battery is a potassium-ion battery.

4. The battery of claim 1, wherein the manganese hexacyanomanganate has an open framework crystal structure into which the ions are reversibly inserted during operation of the battery.

5. The battery of claim 1, wherein the electrode comprises faceted cubic crystals of manganese hexacyanomanganate having at least one dimension of 1 μm or less.

6. The battery of claim 1, wherein a mass loading of the manganese hexacyanomanganate in the electrode is at least 1 mg cm⁻².

7. The battery of claim 1, wherein the electrode has a discharge capacity of at least 200 mAh g⁻¹ at C/5.

8. The battery of claim 1, wherein the electrode has a discharge capacity of at least 170 mAh g⁻¹ at 1 C.

9. The battery of claim 1, wherein the electrode has a discharge capacity of at least 140 mAh g⁻¹ at 5 C.

10. The battery of claim 1, wherein the battery has a Coulombic efficiency of at least 90% after 100 cycles at 2 C.

11. The battery of claim 1, wherein the battery has a Coulombic efficiency of at least 90% after 100 cycles at C/5.

12. A method for making a rechargeable battery, comprising incorporating manganese hexacyanomanganate into an electrode, and contacting the electrode with an electrolyte.

13. The method of claim 12, comprising contacting the electrode with an electrolyte comprising sodium ions.

14. The method of claim 12, comprising contacting the electrode with an electrolyte comprising potassium ions.

15. The method of claim 12, comprising incorporating sodium manganese hexacyanomanganate into the electrode.

16. The method of claim 12, comprising incorporating potassium manganese hexacyanomanganate into the electrode.

17. The method of claim 12, wherein the manganese hexacyanomanganate has an open framework crystal structure into which sodium or potassium ions are reversibly inserted during operation of the battery.

18. The method of claim 12, wherein the electrode comprises faceted cubic crystals of manganese hexacyanomanganate having at least one dimension of 1 μm or less.

19. The method of claim 12, wherein a mass loading of the manganese hexacyanomanganate in the electrode is at least 1 mg cm⁻².

20. The method of claim 12, wherein the electrode further comprises at least one of a conductive material and a binder.
